(19) United States
(12) Patent Application Publication
(10) Pub. No.: US 2026/0296715 A1
(43) Pub. Date: Oct. 1, 2026

(54) GUSSETED CONTAINERS FOR FOOD PRODUCTS

(71) Applicant: Graphic Packaging International, LLC, Atlanta, GA (US)

(72) Inventor: Thomas Brink, West Chicago, IL (US)

(21) Appl. No.: 19/567,711

(22) Filed: Mar. 16, 2026

Related U.S. Application Data
(60) Provisional application No. 63/781,193, filed on Mar. 31, 2025.

(51) Int. Cl. B65D 5/02; B31B 50/73; B31B 50/76; B31B 100/00; B31B 110/30; B65D 5/10

(52) U.S. Cl. CPC B65D 5/029; B31B 50/734; B31B 50/76; B65D 5/10; B31B 2100/00; B31B 2110/30

(57) ABSTRACT

A container for holding at least one food product may comprise a plurality of panels extending at least partially around an interior of the container. The plurality of panels may comprise a bottom panel, a back panel, and at least one side panel. The container may comprise a first attachment end flap foldably connected to the at least one side panel and a second attachment end flap foldably connected to the back panel and the first attachment end flap.

### CROSS-REFERENCE TO RELATED APPLICATION

The present application claims priority to U.S. Provisional Patent Application No. 63/781,193 filed on Mar. 31, 2025.

### INCORPORATION BY REFERENCE

The disclosure of U.S. Provisional Patent Application No. 63/781,193, filed on Mar. 31, 2025 is hereby incorporated by reference for all purposes as if presented herein in its entirety.

### TECHNICAL FIELD

The present disclosure relates to containers for holding food products, blanks for forming such containers, and methods for forming containers from blanks. The disclosure further relates to attachment end flaps and closure mechanisms for securing containers.

### BACKGROUND

Conventional food containers may present challenges for consumers seeking convenient, portable food packaging solutions. Existing containers may be difficult to erect from flat blanks, may require two-handed operation during assembly or use, or may lack secure closure mechanisms for resealing. Traditional food packaging may be prone to structural failure when holding irregularly shaped food items. Additionally, conventional containers may not provide adequate grip features or may have complex assembly requirements that slow manufacturing or increase assembly errors. These limitations can result in consumer dissatisfaction and reduced functionality for portable food service applications.

### SUMMARY OF THE DISCLOSURE

According to one aspect, a container for holding at least one food product may comprise a plurality of panels extending at least partially around an interior of the container. The plurality of panels may comprise a bottom panel, a back panel, and at least one side panel. The container may further comprise a first attachment end flap foldably connected to the at least one side panel and a second attachment end flap foldably connected to the back panel and the first attachment end flap.

In some embodiments, the first attachment end flap may be in at least partial face-to-face alignment with the second attachment end flap. The first attachment end flap may be in at least partial face-to-face alignment with the at least one side panel.

In some embodiments, the at least one side panel may include a first side panel positioned opposite a second side panel and the container may further comprise a third attachment end flap foldably connected to the second side panel and a fourth attachment end flap foldably connected to the back panel.

In some embodiments, the container may further comprise a first closure end flap foldably connected to the first side panel and a second closure end flap foldably connected to the second side panel, wherein the first closure end flap may be in at least partial face-to-face alignment with the second closure end flap. The container may further comprise locking features including a locking tab defined within the first closure end flap and a locking cut at least partially defined in the second closure end flap, the locking cut arranged to at least partially receive the locking tab.

In some embodiments, the container may further comprise a third closure end flap foldably connected to the bottom panel, the third closure end flap in at least partial face-to-face alignment with the second closure end flap. The first side panel may be foldably connected to the bottom panel at a lateral fold line, the first closure end flap foldably connected to the first side panel at an oblique fold line, wherein the oblique fold line forms an angle with the lateral fold line and wherein the angle may be between 35 and 55 degrees.

In some embodiments, the back panel may extend from a first fold line at the bottom panel to a distal end, wherein the back panel may have a first width at the first fold line and a second width at the distal end and wherein the second width may be greater than the first width.

According to another aspect, a blank for forming a container for holding at least one food product may comprise a plurality of panels arranged to extend at least partially around an interior of the container when erected. The plurality of panels may comprise a bottom panel, a back panel, and at least one side panel. The blank may further comprise a first attachment end flap foldably connected to the at least one side panel and a second attachment end flap foldably connected to the back panel and the first attachment end flap.

In some embodiments, the first attachment end flap may be arranged to be in at least partial face-to-face alignment with the second attachment end flap when the blank is erected. The first attachment end flap may be arranged to be in at least partial face-to-face alignment with the at least one side panel when the blank is erected.

In some embodiments, the at least one side panel may include a first side panel positioned opposite a second side panel and the blank may further comprise a third attachment end flap foldably connected to the second side panel and a fourth attachment end flap foldably connected to the back panel.

In some embodiments, the blank may further comprise a first closure end flap foldably connected to the first side panel and a second closure end flap foldably connected to the second side panel, wherein the first closure end flap may be arranged to be in at least partial face-to-face alignment with the second closure end flap when the blank is erected. The blank may further comprise locking features including a locking tab defined within the first closure end flap and a locking cut at least partially defined in the second closure end flap, the locking cut arranged to at least partially receive the locking tab when the blank is erected.

In some embodiments, the blank may further comprise a third closure end flap foldably connected to the bottom panel, the third closure end flap arranged to be in at least partial face-to-face alignment with the second closure end flap when the blank is erected. The first side panel may be foldably connected to the bottom panel at a lateral fold line, the first closure end flap foldably connected to the first side panel at an oblique fold line, wherein the oblique fold line may form an angle with the lateral fold line and wherein the angle may be between 35 and 55 degrees.

In some embodiments, the back panel may extend from a first fold line at the bottom panel to a distal end, wherein the back panel may have a first width at the first fold line and a second width at the distal end and wherein the second width may be greater than the first width.

According to another aspect, a method for forming a container for holding at least one food product may comprise obtaining a blank comprising a plurality of panels, the plurality of panels comprising a bottom panel, a back panel, and at least one side panel. The method may further comprise providing a first attachment end flap foldably connected to the at least one side panel and a second attachment end flap foldably connected to the back panel and the first attachment end flap, and erecting the blank to form the container such that the plurality of panels extend at least partially around an interior of the container.

In some embodiments, the method may further comprise positioning the first attachment end flap in at least partial face-to-face alignment with the second attachment end flap. The method may further comprise positioning the first attachment end flap in at least partial face-to-face alignment with the at least one side panel.

In some embodiments, the at least one side panel may include a first side panel positioned opposite a second side panel and the method may further comprise providing a third attachment end flap foldably connected to the second side panel and a fourth attachment end flap foldably connected to the back panel.

In some embodiments, the method may further comprise providing a first closure end flap foldably connected to the first side panel and a second closure end flap foldably connected to the second side panel and positioning the first closure end flap in at least partial face-to-face alignment with the second closure end flap. The method may further comprise providing locking features including a locking tab defined within the first closure end flap and a locking cut at least partially defined in the second closure end flap and inserting the locking tab at least partially into the locking cut.

In some embodiments, the method may further comprise providing a third closure end flap foldably connected to the bottom panel and positioning the third closure end flap in at least partial face-to-face alignment with the second closure end flap. The first side panel may be foldably connected to the bottom panel at a lateral fold line, the first closure end flap foldably connected to the first side panel at an oblique fold line, wherein the oblique fold line may form an angle with the lateral fold line and wherein the angle may be between 35 and 55 degrees, and the method may further comprise folding the first closure end flap along the oblique fold line.

In some embodiments, the back panel may extend from a first fold line at the bottom panel to a distal end, and the method may further comprise providing the back panel with a first width at the first fold line and a second width at the distal end, wherein the second width may be greater than the first width.

Those skilled in the art will appreciate the above stated advantages and other advantages and benefits of various additional embodiments reading the following detailed description of the embodiments with reference to the below-listed drawing figures. It is within the scope of the present disclosure that the above-discussed aspects be provided both individually and in various combinations.

### BRIEF DESCRIPTION OF THE DRAWINGS

According to common practice, the various features of the drawings discussed below are not necessarily drawn to scale. Dimensions of various features and elements in the drawings may be expanded or reduced to more clearly illustrate the embodiments of the disclosure.

FIG. 1 is a plan view of an exterior surface of a blank for forming a container according to an embodiment of the disclosure.

FIG. 2 a perspective view of a partial formation of a container from the blank of FIG. 1 according to an embodiment of the disclosure.

FIG. 3 is a perspective view of a container formed from the blank of FIG. 1 in an open configuration according to an embodiment of the disclosure.

FIG. 4 is a perspective view of a container formed from the blank of FIG. 1 in an open configuration, according to an embodiment of the disclosure.

FIG. 5 is a perspective view of a container formed from the blank of FIG. 1. in a closed configuration according to an embodiment of the disclosure.

Corresponding parts are designated by corresponding reference numbers throughout the drawings.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Techniques disclosed herein relate generally to containers for food products. More specifically, techniques disclosed herein relate to containers including multiple coupled panels and end flaps that may provide a compact, hand-holdable structure with both a selectively openable and closable end and a gusseted attachment configuration. Various embodiments may be described herein, including containers, blanks for forming containers, methods of forming containers, and the like.

In order to better appreciate the features and aspects of the present disclosure, further context for the disclosure may be provided in the following section by discussing one particular implementation of a container that includes a plurality of coupled panels and end flaps according to embodiments of the disclosure. These embodiments may be for explanatory purposes only and other embodiments may be employed in other food service applications. For example, embodiments of the disclosure may be used with any container that receives, retains, or provides access to food products. In some instances, embodiments of the disclosure may be particularly well suited for use with containers for prepared food products served at quick service food establishment because of their generally tapered, hand-holdable configuration that fits the shape of the food product and their gusseted attachment end flap arrangement that may facilitate simplified erection of the container from a flat blank.

The present disclosure relates to a container for holding one or more food products, a blank for forming such a container, and a method of forming the container from the blank. In general terms, the container may be thought of as a compact, outer sleeve or holder that may receive, retain and provide access to one or more food products. The container may be formed from a flat sheet of paperboard or similar material, referred to as a blank, which may be pre-cut and pre-scored so that it may be folded into a three-dimensional container structure. The blank may include a plurality of panels that, when folded, may extend around an interior of the container to form the walls and floor of the container. The blank may further include a plurality of end flaps that may be folded into position at an end of the container, with some end flaps forming a structurally closed back end of the container and other end flaps forming a selectively openable and closable access end of the container.

The container may have a generally tapered configuration, for example, a generally triangular cross-sectional profile, that may fit comfortably within a single hand of a user and may generally fit the shape of the food product (e.g., half a sandwich, a slice of pie, etc.). The tapered configuration may allow the panels of the container to rest in the palm and adjacent portions of a user's hand, while the fingertips of the user may remain free to manipulate end flaps and associated locking features at the access end of the container. In this regard, the container may be held, formed, opened, and closed using a single hand of a user. The container may thus provide a convenient outer construct by which one or more food products may be held without directly contacting the food products, without squeezing or deforming the food products, and with at least partial protection of the food products from contamination and heat loss.

The blank may include attachment end flaps arranged in a gusseted configuration at one end of the container and closure end flaps arranged at the other end of the container. The gusseted attachment end flaps may facilitate simplified and rapid erection of the container from the flat blank, for example, by collapsing in a gusset-like manner as the panels of the container are raised into their erected positions. The closure end flaps may include locking features, for example, a locking tab and a corresponding locking cut, that may allow the access end of the container to be selectively opened and closed.

Various aspects of the disclosure may be understood further by referring to the figures. For purposes of simplicity, like numerals may be used to describe like features. It will be understood that where a plurality of similar features are depicted, not all of such features necessarily are labeled on each figure. It also will be understood that the various components used to form the constructs may be interchanged. Thus, while only certain combinations are illustrated herein, numerous other combinations and configurations are contemplated hereby.

Containers according to the present disclosure can accommodate articles of numerous different shapes. For the purpose of illustration and not for the purpose of limiting the scope of the disclosure, the following detailed description describes articles such as food products at least partially disposed upon or within the container embodiments.

The articles can include food products such as prepared food products, fresh food products, food products delivered at a quick service restaurant. Accordingly, such food products could include sandwiches, meat products (e.g., ground meat, sliced meat, diced meat, sausage, cured meat, etc.), fish products, fast food products, take-out products, meal leftovers, and the like, or any combination thereof. Examples of such products can include pastries (e.g., filled or frosted pastries), slices of pie, breads, fruit bars, French toast sticks, fish, chicken (such as chicken nuggets, chicken strips, chicken fingers, etc.), popcorn, peanuts, candy, French fries (such as waffle fries, steak fries, shoestring fries, curly fries, etc.), sandwiches, pizza, calzone, turnover, tacos, burritos, enchiladas, chalupas, chimichangas, churros, gorditas, huaraches, quesadillas, tamales, or any other food product that may be provided for consumption by a consumer. Such food products could be provided hot, e.g., at freshly cooked/heated temperatures and/or to taste, though could be served at lower temperatures without departing from the disclosure. In this specification, the terms “inner,” “interior,” “outer,” “exterior,” “lower,” “bottom,” “upper,” and “top” indicate orientations determined in relation to fully erected and upright containers.

As described herein, containers may be formed by multiple overlapping panels, end flaps, and/or other portions of blanks. Such panels, end flaps, and/or other portions of the blanks can be designated in relative terms to one another, e.g., “first”, “second”, “third”, etc., in sequential or non-sequential reference, without departing from the disclosure.

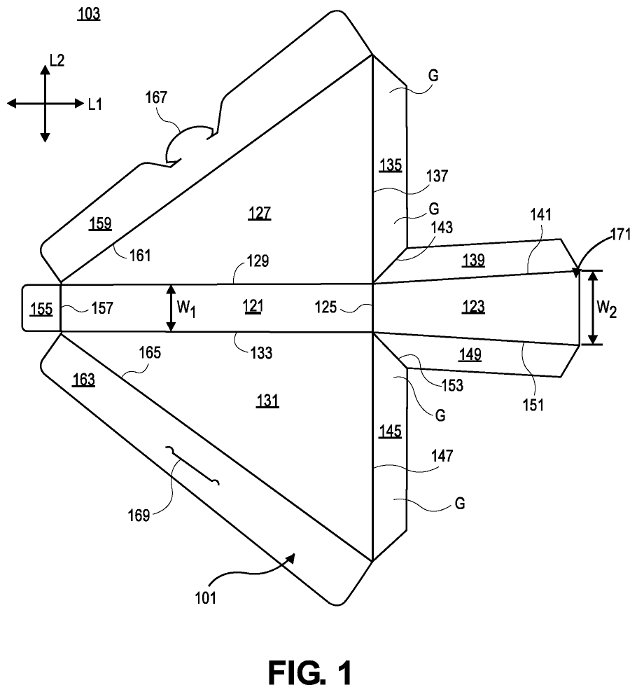

FIG. 1 illustrates an exterior surface 101 of blank 103 for forming a container 105 according to an embodiment of the disclosure. The blank 103 can have a longitudinal axis L1 and a lateral axis L2, as shown, though different reference axes could be used without departing from the disclosure.

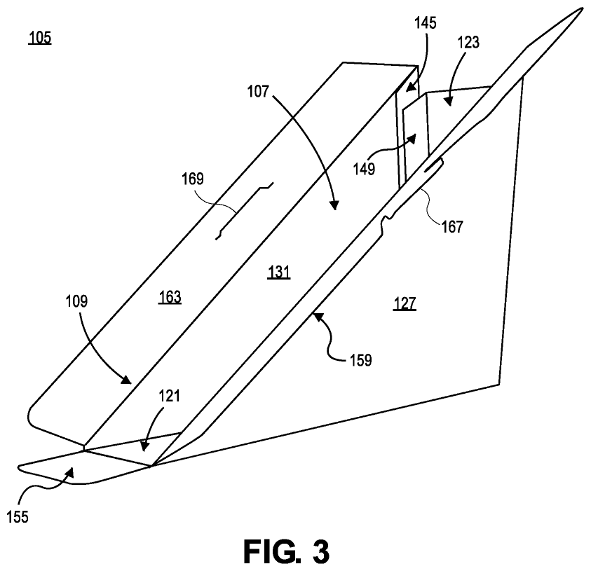

The blank 103 and the container 105 formed therefrom can include a plurality of panels for extending at least partially around an interior 107 (see e.g., FIG. 3) of the container 105, and can include a generally elongate bottom panel 121, a spine or back panel 123 foldably connected to the bottom panel 121 at a lateral fold line 125, a first side panel 127 foldably connected to the bottom panel 121 at a longitudinal fold line 129, and a second side panel 131 foldably connected to the bottom panel 121 at a longitudinal fold line 133. The back panel 123 can extend from the lateral fold line 125 to a distal end 171. The back panel 123 can have a first width W₁ at the lateral fold line 125 and a second width W₂ at the distal end 171. The second width W₂ can be greater than, less than, or equal to the first width W₁.

In the illustrated embodiment, the side panels 127, 131 can have a generally triangular configuration, though one or both of the side panels 127, 131 could have a different configuration without departing from the disclosure. In some embodiments, the first side panel 127 can be arranged such that the longitudinal fold line 129 and an oblique fold line 161 are arranged at between and including about a 35 degree angle and about a 55 degree angle, for example, about a 45 degree angle. Similarly, the second side panel 131 can be arranged such that the longitudinal fold line 133 and an oblique fold line 165 are arranged at between and including about a 35 degree angle and about a 55 degree angle, for example, about a 45 degree angle.

A plurality of end flaps can be foldably connected to a respective panel of the plurality of panels of the blank 103 and container 105 formed therefrom. As shown, a first attachment end flap 135 can be foldably connected to the first side panel 127 at a lateral fold line 137 and a second attachment end flap 139 can be foldably connected to the back panel 123 at a longitudinal or oblique fold line 141. The attachment end flaps 135, 139 can be foldably connected to one another at an oblique fold line 143, as shown, so as to have an at least partially gusseted configuration.

Similarly, a third attachment end flap 145 can be foldably connected to the second side panel 131 at a lateral fold line 147 and a fourth attachment end flap 149 can be foldably connected to the back panel 123 at a longitudinal or oblique fold line 151. The attachment end flaps 145, 149 can be foldably connected to one another at an oblique fold line 153, as shown, so as to have an at least partially gusseted configuration.

The plurality of end flaps can also include a plurality of closure end flaps. As shown, a first (e.g., second or third, etc.) closure end flap 155 can be foldably connected to the bottom panel 121 at a lateral fold line 157, a second (e.g., first or third, etc.) closure end flap 159 can be foldably connected to the first side panel 127 at an oblique fold line 161, and a third (e.g., first or second, etc.) closure end flap 163 can be foldably connected to the second side panel 131 at an oblique fold line 165.

As described herein, in a closed configuration of the container, the closure end flaps can be at least partially overlapped to provide a closed end of the container 105 formed from the blank 103. Similarly, the closure end flaps can be arranged to provide an open configuration of such end of the container 105. In this regard, the blank 103 and container 105 can include locking features for at least partially maintaining a closed configuration of the container 105. The locking features can include a locking tab 167 at least partially extending away from the second closure end flap 159, and a locking cut 169 at least partially formed in the third closure end flap 163 for at least partially receiving the locking tab 167 therethrough. The locking cut 169, as shown, can include one or more of straight, curved, and angled segments, and can include one or more relief portions extending therefrom.

It will be understood that one or more portions of the blank 103 can have a different configuration without departing from the disclosure.

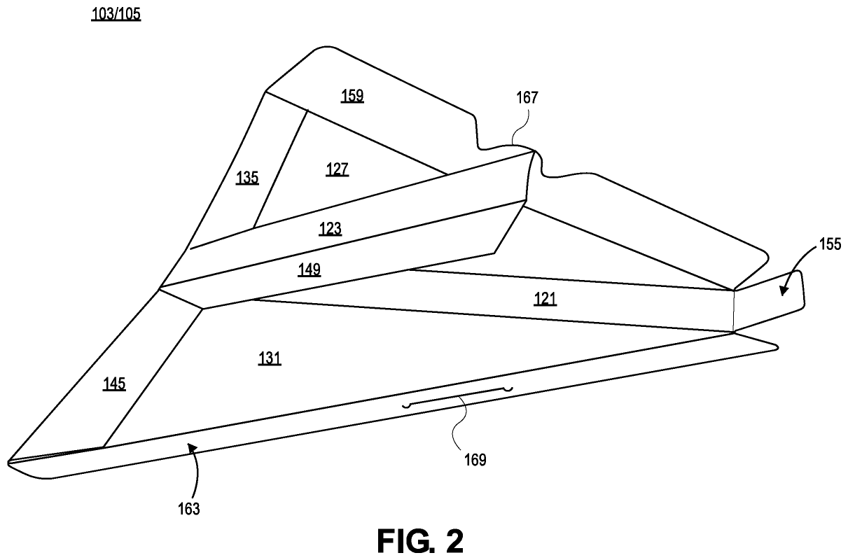

With additional reference to FIGS. 2-4, formation of the container 105 from the blank 103 according to some embodiments of the disclosure will be described. Referring to FIG. 2, as shown, the blank 103 can be inverted, e.g., such that the exterior surface 101 is positioned resting on a table, portion of a forming assembly, or other supporting surface. The back panel 123 can be at least partially folded at the fold line 125 into at least partial face-to-face contact with a respective portion of the bottom panel 121.

Such movement of the back panel 123 can cause, or an operator and/or element of a forming assembly can cause, the first attachment end flap 135 to at least partially fold at the fold line 137 into at least partial face-to-face contact with the first side panel 127 and the second attachment end flap 139 to at least partially fold at the fold line 141 into at least partial face-to-face contact with the back panel 123. This movement of the attachment end flaps 135, 139 can include at least partial folding therebetween at the fold line 143 such that the attachment end flaps 135, 139 fold like a gusset.

Similarly, the third attachment end flap 145 can be caused to at least partially fold at the fold line 147 into at least partial face-to-face contact with the second side panel 131 and the fourth attachment end flap 149 can be caused to at least partially fold at the fold line 151 into at least partial face-to-face contact with the back panel 123. This movement of the attachment end flaps 145, 149 can include at least partial folding therebetween at the fold line 153 such that the attachment end flaps 145, 149 fold like a gusset.

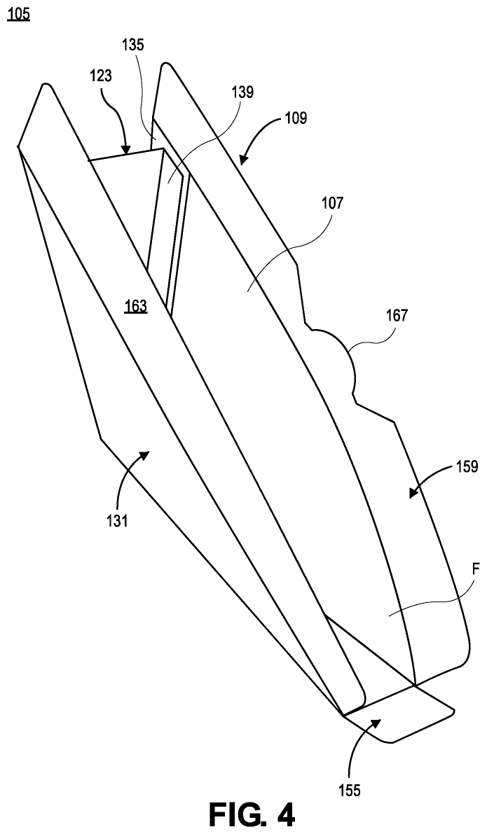

Referring to FIG. 3 and FIG. 4, the side panels 127, 131 can be raised relative to the bottom panel 121 at the respective fold lines 129, 133. In such an arrangement, the exterior surfaces (e.g., those corresponding to the exterior surface 101 of the blank 103) of the attachment end flaps 135, 139 can be positioned in at least partial face-to-face contact and the exterior surfaces of the attachment end flaps 145, 149 can be positioned in at least partial face-to-face contact.

Simultaneously or thereafter, the back panel 123 can be raised at the fold line 125 into generally upright relation with the bottom panel 121. In some embodiments, the back panel 123 can be generally perpendicularly arranged relative to the bottom panel 121, though the back panel 123 can be obliquely arranged relative to the bottom panel 121 without departing from the disclosure.

The container 105 can thus be formed in the open configuration shown. In some embodiments, the formed configuration of the container 105 can be at least partially maintained with one or more applications of an adhesive such as glue G (FIG. 1). As shown, glue G can be applied to the exterior surfaces of the attachment end flaps 135, 145, through a different arrangement of adhesive or a different modality of maintaining a formed configuration of the container 105 could be provided without departing from the disclosure.

In the open configuration of the container 105 shown in FIG. 3 and FIG. 4, in which one or more of the closure end flaps 159, 163 are raised away from the interior 107 of the container 105, an end 109 of the container 105 is open to the interior 107 thereof to provide a point of entry for loading one or more food products F therein and/or for retrieving one or more food products F therethrough.

The one or more food products F in the interior 107 of the container 105 can be food products F prepared at a quick service restaurant. In this regard, such food products F may be provided ready to eat/serve, or may be provided with an associated packaging, wrapping, etc.

Regardless, the container 105 provides an outer construct by which one or more food products F can be conveniently held in a hand of a customer or other user, e.g., so as to avoid squeezing and deforming such food product(s) F, to avoid directly contacting such food product(s) F, e.g., to avoid contact with grease, runoff, etc. Furthermore, the container 105 can provide protection for one or more food product(s) F held therein, e.g.,. from deformation, from contamination from a surrounding environment, etc. Further still, the container 105 can at least partially inhibit the loss of head from the food product(s) F in the container 105 to the surrounding environment, so as to at least partially maintain a condition of the one or more food product(s) F. In some embodiments, the interior 107 of the container 105 can provide a receptacle for including one or more accessories related to food products, for example, napkins, wipes, condiments, etc. In addition, the interior 107 of the container 105 can be used to store leftovers or waste associated with food products.

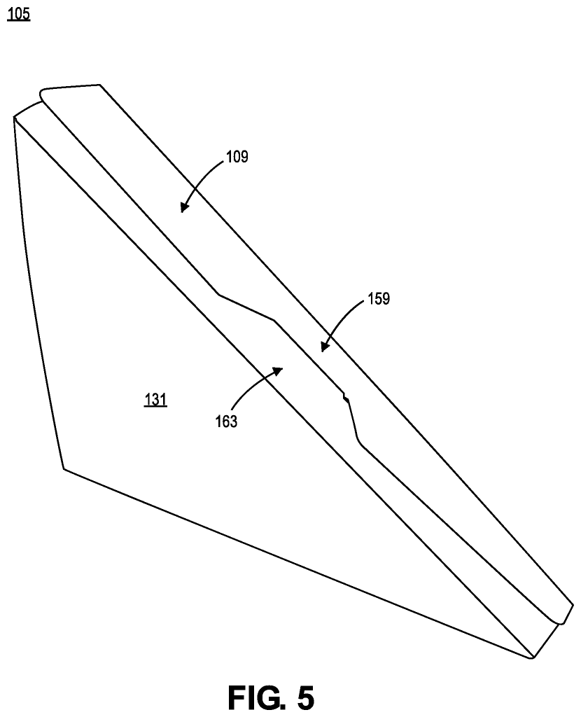

With additional reference to FIG. 5, the end 109 of the container 105 can be closed by at least partially folding the first closure end flap 155 at the fold line 157 toward the end 109, at least partially folding the third closure end flap 163 at the fold line 165 into at least partial overlapping relation with the first closure end flap 155, and at least partially folding the second closure end flap 159 into at least partial overlapping relation with the third closure end flap 163.

As also shown, the locking tab 167 can be at least partially inserted through the locking cut 169 to maintain the closed configuration of the end 109 of the container 105. The locking tab 167 can be withdrawn from the locking cut 169 to facilitate movement of the closure end flaps 155, 159, 163 to reconfigure the end 109 of the container 105 from the closed configuration to the open configuration. In some embodiments, such closure/locking and opening/unlocking of the end 109 of the container 105 can be accomplished via a single handed grip by a user, e.g., with the panels 121, 123, 127, 131 generally held in the palm and adjacent portions of a user's hand, and with distal portions of a user's fingertips free to move the closure flaps 159, 163 and associated locking features.

In some embodiments, the container 105 could be provided without closure flaps, such that the end 109 thereof is open so that the container 105 is configured in a sleeve or holder arrangement.

The container 105 is thus provided to hold one or more food products in a conveniently formed and easy to hold configuration that provides for ease of access to the interior 107 thereof. In some embodiments, formation and/or grasping of the container 105 can be accomplished with a single hand of a user or operator, owing to the generally tapered, e.g., triangular, configuration of the container 105 and the gusseted/folded arrangement of the attachment end flaps 135/139, 145/149 that facilitate formation of the container 105. Such a configuration provides an advantage over containers that, for example, lack the ease of access of the tapered profile of the container 105 and which involve additional forming steps that can complicate manufacturing and use.

It will be understood that one or more portions of the container 105 could be differently configured without departing from the disclosure.

Any of the features of the various embodiments of the disclosure can be combined with, replaced by, or otherwise configured with other features of other embodiments of the disclosure without departing from the scope of this disclosure. Further, it is noted that the nesting arrangements and/or the features of the blanks and cartons of the various embodiments can be incorporated into a container or blank having any container style or panel configuration. The container styles and panel configurations described above are included by way of example.

The blanks according to any of the embodiments of the present disclosure can be, for example, formed from coated paperboard and similar materials. For example, the interior and/or exterior sides of the blank can be coated with a clay coating. The clay coating may then be printed over with product, advertising, price coding, and other information or images. The blank may then be coated with a varnish to protect any information printed on the blank. The blank may also be coated with, for example, a moisture barrier layer, on either or both sides of the blank. In accordance with the above-described embodiments, the blank may be constructed of paperboard of a caliper such that it is heavier and more rigid than ordinary paper. The blank can also be constructed of other materials, such as cardboard, hard paper, or any other material having properties suitable for enabling the carton to function at least generally as described herein. The blank can also be laminated or coated with one or more sheet-like materials at selected panels or panel sections.

In accordance with the above-described embodiments of the present disclosure, a fold line can be any substantially linear, although not necessarily straight, form of weakening that facilitates folding therealong. More specifically, but not for the purpose of narrowing the scope of the present disclosure, fold lines include: a score line, such as lines formed with a blunt scoring knife, or the like, which creates a crushed portion in the material along the desired line of weakness; a cut that extends partially into a material along the desired line of weakness, and/or a series of cuts that extend partially into and/or completely through the material along the desired line of weakness; and various combinations of these features.

As an example, a tear line can include: a slit that extends partially into the material along the desired line of weakness, and/or a series of spaced apart slits that extend partially into and/or completely through the material along the desired line of weakness, or various combinations of these features. As a more specific example, one type tear line is in the form of a series of spaced apart slits that extend completely through the material, with adjacent slits being spaced apart slightly so that a nick (e.g., a small somewhat bridging-like piece of the material) is defined between the adjacent slits for typically temporarily connecting the material across the tear line. The nicks are broken during tearing along the tear line. The nicks typically are a relatively small percentage of the tear line, and alternatively the nicks can be omitted from or torn in a tear line such that the tear line is a continuous cut line. That is, it is within the scope of the present disclosure for each of the tear lines to be replaced with a continuous slit, or the like. For example, a cut line can be a continuous slit or could be wider than a slit without departing from the present disclosure.

In accordance with the embodiments, a fold line can be any substantially linear, although not necessarily straight, form of weakening that facilitates folding therealong. More specifically, but not for the purpose of narrowing the scope of the present disclosure, fold lines include: a score line, such as lines formed with a blunt scoring knife, or the like, which creates a crushed or depressed portion in the material along the desired line of weakness; a cut that extends partially into a material along the desired line of weakness, and/or a series of cuts that extend partially into and/or completely through the material along the desired line of weakness; and various combinations of these features. In situations where cutting is used to create a fold line, typically the cutting will not be overly extensive in a manner that might cause a reasonable user to incorrectly consider the fold line to be a tear line.

The above embodiments may be described as having one or more panels adhered together by glue during erection of the carrier embodiments. The term “glue” is intended to encompass all manner of adhesives commonly used to secure carrier panels in place.

The foregoing description of the disclosure illustrates and describes various embodiments. Various additions, modifications, changes, etc., could be made to the embodiments without departing from the spirit and scope of the disclosure. It is intended that all matter contained in the above description or shown in the accompanying drawings shall be interpreted as illustrative and not in a limiting sense. Additionally, the disclosure shows and describes only selected embodiments of the disclosure, but the disclosure is capable of use in various other combinations, modifications, and environments and is capable of changes or modifications within the scope of the inventive concept as expressed herein, commensurate with the above teachings, and/or within the skill or knowledge of the relevant art. Furthermore, certain features and characteristics of each embodiment may be selectively interchanged and applied to other illustrated and non-illustrated embodiments of the disclosure.

What is claimed is:

1. A container for holding at least one food product, the container comprising:
a plurality of panels extending at least partially around an interior of the container, the plurality of panels comprising:
a bottom panel, a back panel, and at least one side panel; and
a first attachment end flap foldably connected to the at least one side panel and
a second attachment end flap foldably connected to the back panel and the first attachment end flap.

2. The container of claim 1, wherein the first attachment end flap is in at least partial face-to-face alignment with the second attachment end flap.

3. The container of claim 1, wherein the first attachment end flap is in at least partial face-to-face alignment with the at least one side panel.

4. The container of claim 1, wherein the at least one side panel includes a first side panel positioned opposite a second side panel and wherein the container further comprises a third attachment end flap foldably connected to the second side panel and a fourth attachment end flap foldably connected to the back panel.

5. The container of claim 4, wherein the container further comprises a first closure end flap foldably connected to the first side panel and a second closure end flap foldably connected to the second side panel, wherein the first closure end flap is in at least partial face-to-face alignment with the second closure end flap.

6. The container of claim 5, further comprising locking features including a locking tab defined within the first closure end flap and a locking cut at least partially defined in the second closure end flap, the locking cut arranged to at least partially receive the locking tab.

7. The container of claim 5, wherein the container further comprises a third closure end flap foldably connected to the bottom panel, the third closure end flap in at least partial face-to-face alignment with the second closure end flap.

8. The container of claim 5, wherein the first side panel is foldably connected to the bottom panel at a lateral fold line, the first closure end flap foldably connected to the first side panel at an oblique fold line, wherein the oblique fold line forms an angle with the lateral fold line and wherein the angle is between 35 and 55 degrees.

9. The container of claim 1, wherein the back panel extends from a first fold line at the bottom panel to a distal end, wherein the back panel has a first width at the first fold line and a second width at the distal end and wherein the second width is greater than the first width.

10. A blank for forming a container for holding at least one food product, the blank comprising:
a plurality of panels arranged to extend at least partially around an interior of the container when erected, the plurality of panels comprising:
a bottom panel, a back panel, and at least one side panel; and
a first attachment end flap foldably connected to the at least one side panel and a second attachment end flap foldably connected to the back panel and the first attachment end flap.

11. The blank of claim 10, wherein the first attachment end flap is arranged to be in at least partial face-to-face alignment with the second attachment end flap when the blank is erected.

12. The blank of claim 10, wherein the first attachment end flap is arranged to be in at least partial face-to-face alignment with the at least one side panel when the blank is erected.

13. The blank of claim 10, wherein the at least one side panel includes a first side panel positioned opposite a second side panel and wherein the blank further comprises a third attachment end flap foldably connected to the second side panel and a fourth attachment end flap foldably connected to the back panel.

14. The blank of claim 13, wherein the blank further comprises a first closure end flap foldably connected to the first side panel and a second closure end flap foldably connected to the second side panel, wherein the first closure end flap is arranged to be in at least partial face-to-face alignment with the second closure end flap when the blank is erected.

15. The blank of claim 14, further comprising locking features including a locking tab defined within the first closure end flap and a locking cut at least partially defined in the second closure end flap, the locking cut arranged to at least partially receive the locking tab when the blank is erected.

16. The blank of claim 14, wherein the blank further comprises a third closure end flap foldably connected to the bottom panel, the third closure end flap arranged to be in at least partial face-to-face alignment with the second closure end flap when the blank is erected.

17. The blank of claim 14, wherein the first side panel is foldably connected to the bottom panel at a lateral fold line, the first closure end flap foldably connected to the first side panel at an oblique fold line, wherein the oblique fold line forms an angle with the lateral fold line and wherein the angle is between 35 and 55 degrees.

18. The blank of claim 10, wherein the back panel extends from a first fold line at the bottom panel to a distal end, wherein the back panel has a first width at the first fold line and a second width at the distal end and wherein the second width is greater than the first width.

19. A method for forming a container for holding at least one food product, the method comprising:
obtaining a blank comprising a plurality of panels, the plurality of panels comprising a bottom panel, a back panel, and at least one side panel;
the blank further comprising a first attachment end flap foldably connected to the at least one side panel and a second attachment end flap foldably connected to the back panel and the first attachment end flap; and
erecting the blank to form the container such that the plurality of panels extend at least partially around an interior of the container.

20. The method of claim 19, further comprising positioning the first attachment end flap in at least partial face-to-face alignment with the second attachment end flap.

21. The method of claim 19, further comprising positioning the first attachment end flap in at least partial face-to-face alignment with the at least one side panel.

22. The method of claim 19, wherein the at least one side panel includes a first side panel positioned opposite a second side panel and wherein the method further comprises providing a third attachment end flap foldably connected to the second side panel and a fourth attachment end flap foldably connected to the back panel.

23. The method of claim 22, further comprising:
providing a first closure end flap foldably connected to the first side panel and a second closure end flap foldably connected to the second side panel; and
positioning the first closure end flap in at least partial face-to-face alignment with the second closure end flap.

24. The method of claim 23, further comprising:
providing locking features including a locking tab defined within the first closure end flap and a locking cut at least partially defined in the second closure end flap; and
inserting the locking tab at least partially into the locking cut.

25. The method of claim 23, further comprising:
providing a third closure end flap foldably connected to the bottom panel; and
positioning the third closure end flap in at least partial face-to-face alignment with the second closure end flap.

26. The method of claim 23, wherein the first side panel is foldably connected to the bottom panel at a lateral fold line, the first closure end flap foldably connected to the first side panel at an oblique fold line, wherein the oblique fold line forms an angle with the lateral fold line and wherein the angle is between 35 and 55 degrees, and wherein the method further comprises folding the first closure end flap along the oblique fold line.

27. The method of claim 26, wherein the back panel extends from a first fold line at the bottom panel to a distal end, and wherein the method further comprises providing the back panel with a first width at the first fold line and a second width at the distal end, wherein the second width is greater than the first width.
